(19) United States
(12) Patent Application Publication
(10) Pub. No.: US 2017/0363130 A1
(43) Pub. Date: Dec. 21, 2017

(54) HIGH STRENGTH FASTENERS, DRIVERS, AND FASTENER SYSTEMS

(71) Applicant: Phillips Screw Company, Burlington, MA (US)

(72) Inventors: Gary Dilling, Gardiner, MA (US); Stefan Szczurek, Leicester (GB)

(21) Appl. No.: 15/616,482

(22) Filed: Jun. 7, 2017

Related U.S. Application Data
(60) Provisional application No. 62/351,540, filed on Jun. 17, 2016.

(51) Int. Cl. F16B 23/00; B25B 15/00; B23G 1/02

(52) U.S. Cl. CPC F16B 23/0053; F16B 23/003; B23G 1/02; B25B 15/005

(57) ABSTRACT

Fasteners, drivers, and fastener systems constructed wherein example fasteners have driver engageable surfaces on or within a shank tip of the fastener. Example embodiments are included where at least one of the installation and removal surfaces are configured to define a segment of a spiral. Some example embodiments are also included where the installation and removal drive surfaces intersect an enlarged core diameter in an inner transitional surface that extends between the installation and removal surfaces of adjacent wings. Embodiments include fasteners with installation and removal drive surfaces on or within a shank tip of fasteners.

### CROSS-REFERENCE TO RELATED APPLICATION

This application claims priority under 35 U.S.C. §119(e) to U.S. Provisional Patent Application Ser. No. 62/351,540, filed on Jun. 17, 2016, which is hereby incorporated by reference in its entirety.

### BACKGROUND

The disclosed embodiments generally relate to fastener systems including fastener, driver, method of manufacture and related tooling, and in particular to fasteners having spiral drive and removal surfaces that enable high seating torques to be applied without excessive stress on the fastener and driver.

Fasteners having driver engageable surfaces that are, at least in part, defined by spiral segments have been used with good results. Fastener systems of this type are described in U.S. Pat. Nos. 5,957,645, 6,234,914, and 6,367,358 issued to Stacy (the Stacy patents), and U.S. Pat. Nos. 7,891,274, 8,171,826, and 8,387,491 issued to Dilling (the Dilling patents), all of which are commonly owned with this application. The disclosures of these patents are incorporated herein by reference in each of their entireties. The drive surfaces of the Stacy patents are constructed to maximize torque transmission, during installation and removal, while spreading the driving load over a broad driver/fastener interface. The thrust of these teachings is to enlarge the area of the drive surfaces. The Dilling patents discuss increases in driver strength and seating torque capability through the use of an increased core diameter.

More recently certain applications have been found that require the application of high seating torques to the fastener. Such torques may exceed the strength limits of the drivers used to seat the fastener and thus result in breaking the driver or damaging the fastener. Therefore, improvements are needed to provide an improved driver/fastener interface to increase the available seating torque characteristic of the fastener system without detrimental impact to the fastener or driver.

### SUMMARY

Embodiments disclosed herein include fasteners, drivers, fastener systems, and methods of forming fasteners and drivers. In one example, a fastener system may include a fastener having a head, a shank, and a recess, and the recess includes driver engageable surfaces that define a plurality of wings radially extending from a central core. In one example, a fastener system may include a driver having an end constructed with mating surfaces for engagement with driver engageable surfaces of a fastener recess, and the mating surfaces define a plurality of projections radially extending from a central core matching the wings. And in yet another example, each of the wings of a recess include a cross sectional shape comprising an installation surface, an outer transition surface, and a removal surface that define the wing, and each of the wings are connected by an inner transition surface extending between the installation and removal surfaces of adjacent wings. And in one example, a cross sectional shape comprises a wing having a width and a height and the ratio of the wing height to the wing width is approximately equal to or less than 0.4 In one example, the driver engageable surfaces of the recess are constructed to receive the mating surfaces of the driver.

Embodiments disclosed herein include fastener systems, an example of which includes a recess central core having a first radius and the outer transition surface having a second radius and the ratio of the first radius to the second radius is greater than 0.70. In one example, a recess central core has a first radius and the outer transition surface has a second radius and wherein the ratio of the first radius to the second radius is greater than 0.77. And in another example, the recess central core has a first radius and the outer transition surface has a second radius and wherein the ratio of the first radius to the second radius is within the range of about 0.77 to about 0.78. An in another example, driver engageable surfaces are constructed in the shape of a spiral segment and mating surfaces have a matching shape. And in yet another example, the wings are arranged in a pentalobular configuration.

In one example, the recess and/or driver includes five wings. And in another example, the shank is a threaded shank having a shank tip on an opposite end of the fastener from the head, and the recess is recessed in the shank tip. In one example, mating surfaces are external surfaces on a driver end. And in yet another example, the driver engageable surfaces are external surfaces of the shank tip and the mating surfaces are recessed in a driver end. In one example, an inner transition surface conforms to a circumference of the central core. And in yet another example, a threaded shank comprises external threads having a major diameter at a thread crest and a minor diameter at a thread root, the fastener has a central core diameter at the inner transition surface, and the ratio of the central core diameter to the major diameter is greater than about 0.3.

In one example, the ratio of the central core diameter to the major diameter is between about 0.3 to about 0.45. In another example the ratio of the central core diameter to the major diameter is greater than about 0.38 and less than about 0.50. In another example the threaded shank has a threaded portion and an unthreaded portion, the unthreaded portion being between the threaded portion and the head. An in yet another example, driver engageable surfaces are countersunk from the shank tip in a longitudinal direction toward the head.

In one example fastener, a countersink is chamfered from a first diameter to a second diameter, the first diameter being larger than the second diameter and the first diameter being closer to the shank tip than the second diameter. In another example, a chamfer has a chamfer angle of about 100 degrees. And in yet another example the driver end is chamfered to a point, the chamfer having an angle of between about 16 degrees and about 17 degrees. In one example, the driver comprises a shaft. And in another example, the driver shaft is chamfered toward the mating surfaces at an angle of about 30 degrees with respect to a longitudinal axis of the driver. And in yet another example the driver further comprises a countersink region corresponding to a countersink of the recess, the driver countersink being chamfered at an angle less than the chamfer angle of the recess countersink. In a further example, the chamfer angle of the driver countersink is about 80 degrees and a chamfer angle of the recess countersink is about 100 degrees.

In one disclosed example, a driver shaft bit includes at least one notch. In another example a driver comprises a shaft. And in yet another example, driver engageable surfaces extend a length from the shank tip, and the mating surfaces of the driver extend a length from the shaft, the length from the shank tip being greater than the length from the shaft.

In one disclosed fastener example, a fastener may include, a head, a shank, and a recess, and the recess comprises driver engageable surfaces that define a plurality of wings radially extending from a central core. In one example, each of said wings of the recess include a cross sectional shape having an installation surface, an outer transition surface, and a removal surface that define the wing, and each of the wings are connected by an inner transition surface extending between the installation and removal surfaces of adjacent wings. In one example fastener, at least one of the installation and removal surfaces are configured to define a segment of a spiral, and in yet another example, the driver engageable surfaces of the recess are constructed to receive mating surfaces of the driver. In a further example, the shank has a shank tip on an opposite end of the fastener from the head, and the recess is recessed in the shank tip.

Disclosed herein are methods of manufacturing fasteners. In one example, the method includes a method of manufacturing a fastener having a head, a shank, and a shank tip on an opposite end of the fastener from the head. In one example, the method includes forming a starter hole. In another example, the method includes, forming driver engageable surfaces that define a plurality of wings radially extending from a central core, and each of said wings of the recess comprise a cross sectional shape comprising an installation surface, an outer transition surface, and a removal surface that define the wing, and each of the wings are connected by an inner transition surface extending between the installation and removal surfaces of adjacent wings. And in yet another example, at least one of the installation and removal surfaces are configured to define a segment of a spiral. In one disclosed example, forming driver engageable surfaces includes broaching. And in yet another example, forming driver engageable surfaces comprises punching.

Additional details will be provided in the accompanying figures and the detailed description below.

### BRIEF DESCRIPTION OF THE DRAWINGS

FIG. 1 shows a perspective view of a fastener in accordance with disclosed embodiments;

FIG. 2 shows a side and section view of a fastener in accordance with disclosed embodiments;

FIGS. 3A and 3B show end views of a fastener in accordance with disclosed embodiments;

FIG. 4 shows a perspective view of a fastener driver in accordance with disclosed embodiments;

FIG. 5A-5D show side and end views of a fastener driver in accordance with disclosed embodiments;

FIGS. 6A and 6B show a cross section of a driver in accordance with disclosed embodiments.

### DETAILED DESCRIPTION

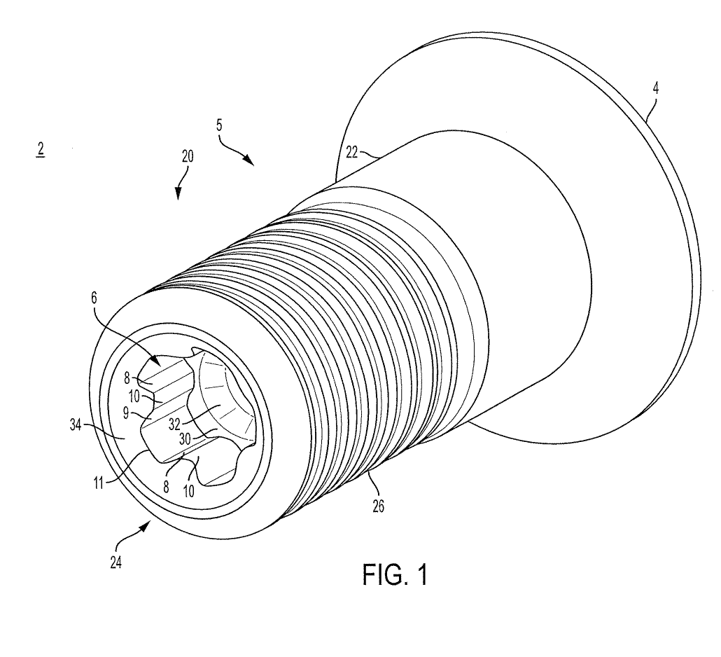

FIGS. 1-6 illustrate, as an example, a fastener and driver bit of a fastener system having features of various embodiment of this application. Although the embodiments disclosed will be described with reference to the drawings, it should be understood that they may take many alternate forms including other dimensions.

An example fastener, according to the present application is shown in FIGS. 1 through 3. Fastener pin (or pin) 2 is constructed having a head 4 and a threaded shank 5. The head 4 may have any configuration known in the art, and is shown in FIG. 1 as having an outer diameter larger than that of threaded shank 5 along with a flat recessed head, which is chamfered and connected to threaded shank 5. The threaded shank 5 may, in one example, have a threaded portion 20 and an unthreaded portion or body 22.

Threaded portion 20 includes threads 26 having a major diameter 28 and a minor diameter 29. In one example, a spirally configured recess 6 is formed in a shank tip 24 opposite the head 4. Such a pin may be used, for example, in a number of machining or assembly applications where the threads and driver can be accessible from the same side of the pin. For example, in the assembly of aircraft, or any other application that could utilize one-sided installation of a threaded fastener. The pin 2, may be used for example, in conjunction with a torque nut or any other female threaded receiver known in the art. The recess 6 may be formed, for example, via broaching, punching, or any other method known to a person of ordinary skill after reading this disclosure.

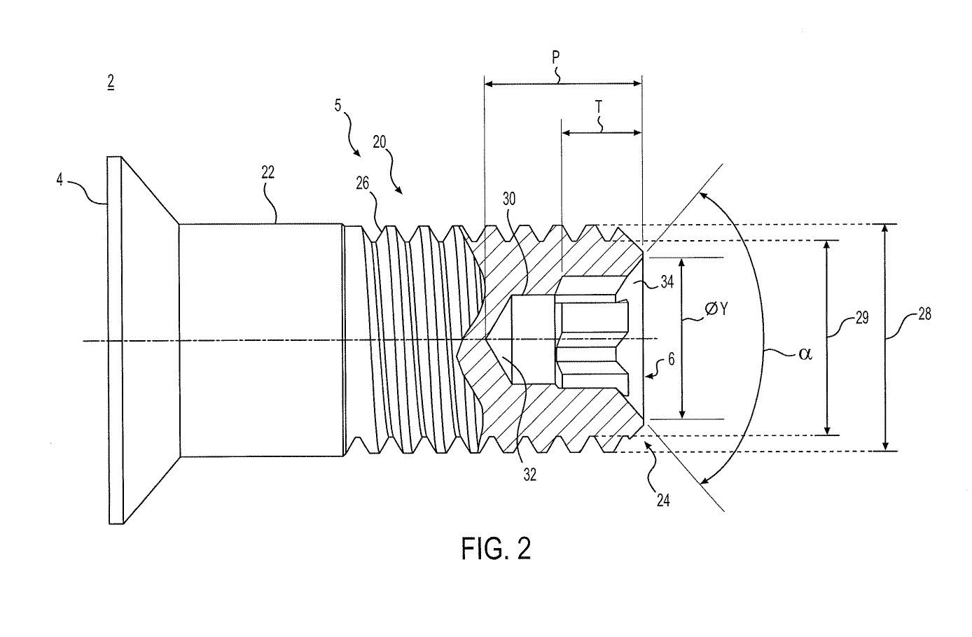

The recess 6, in one example, includes driver engageable surfaces for cooperation with the driver bit 3 to apply torque to the pin 2. These driver engageable surfaces will be discussed in more detail below. The recess 6 may also include additional non-driving features including an extended portion 30 and recess tip 32, which in one example, function as a starter hole for forming the wings of the recess via broaching. Extended portion 30 and recess tip 32, in another example, provides a location for the material removed during forming the recess wings to settle during manufacturing. In, one example of broaching, the pin 2 is started with a hole and the wings/recess are broached or formed by shaving the material into the end of the starter hole. In certain example applications (or customer specifications), the shaved materials (commonly known as petals) are required to be removed to avoid FOD (Foreign Object Debris) in, typically, an airframe assembly, or other highly sensitive industries. This remove can be carried out by a post process drilling process. The recess 6 may also include a countersink 34. The countersink 34 may be chamfered from the top of the recess in a direction towards the bottom of the recess, as shown for example in FIG. 2, and have a chamfer angle α, which can be, in one example, about 100 degrees. The length of the recess from the top of the recess 6/countersink 34 to the recess tip 32 has a length P, which may vary depending on the recess size. The length of the recess from the top of the recess 6/countersink 34 to the bottom of the driver engageable surfaces has a length T, which may also vary with the recess size.

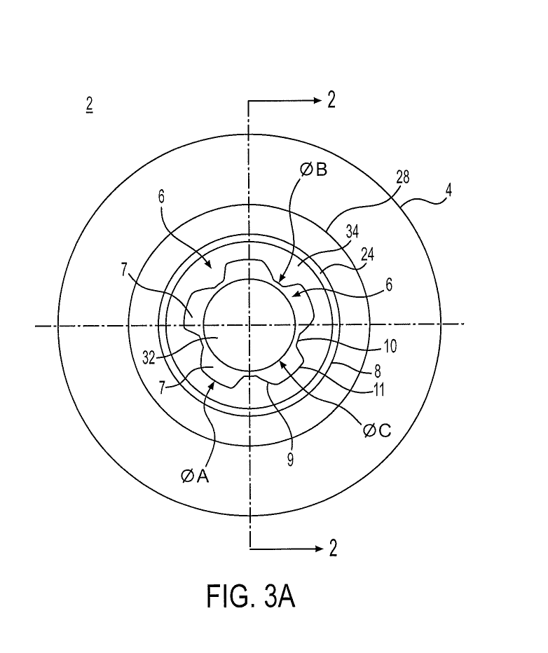

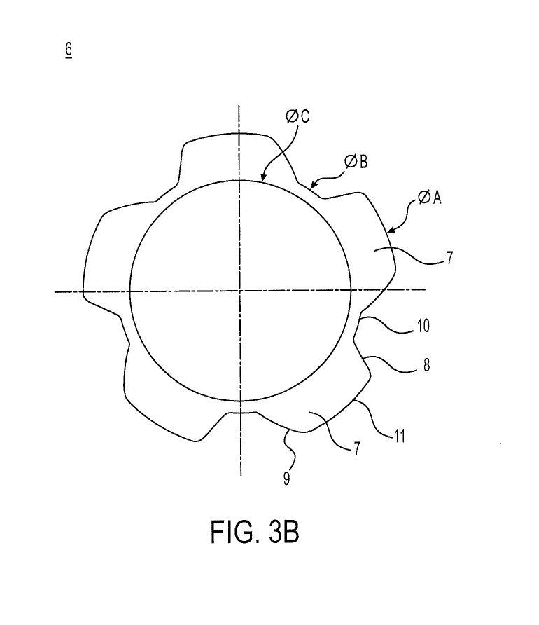

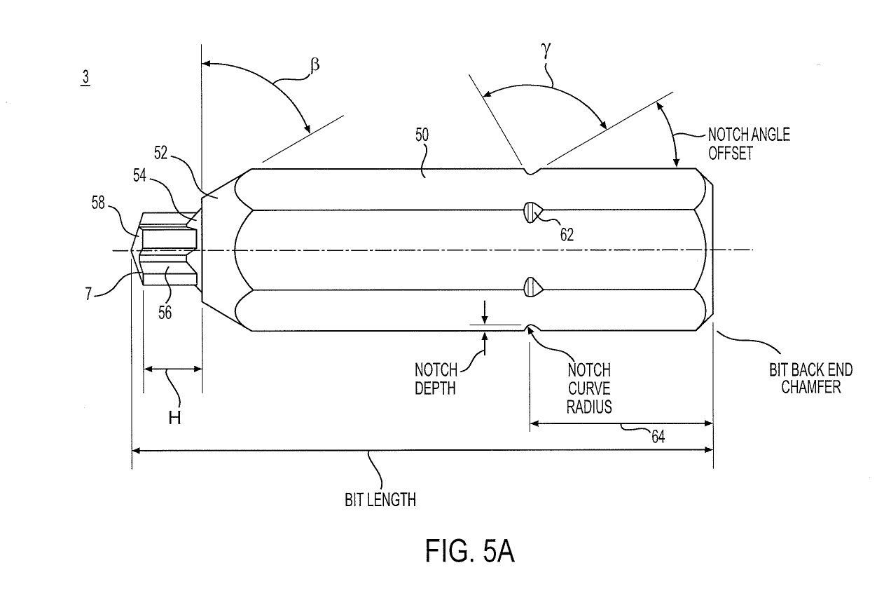

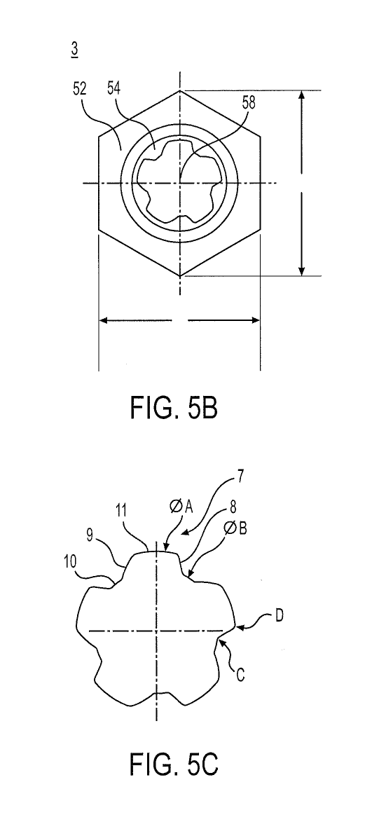

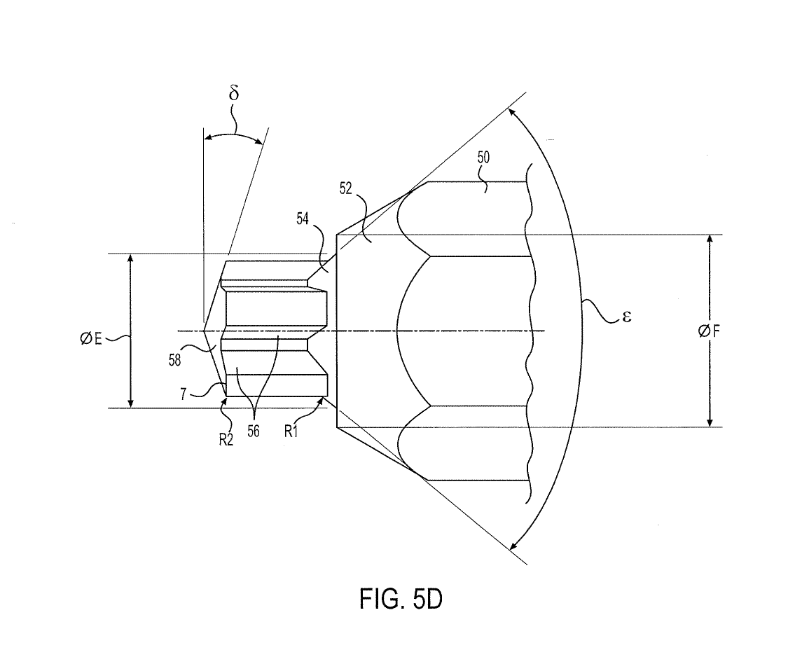

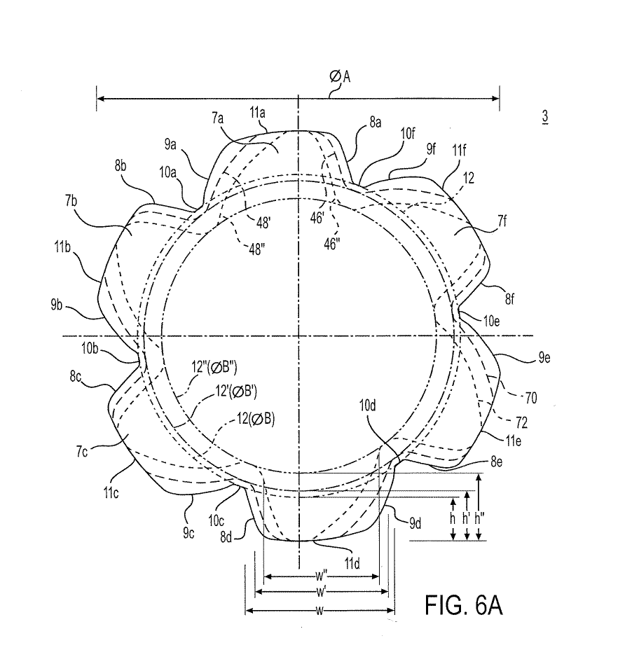

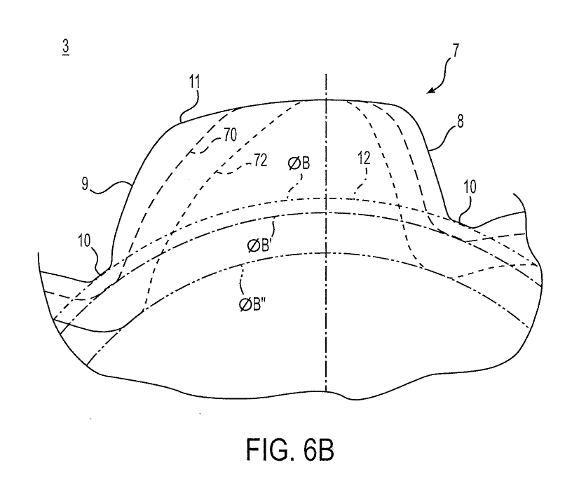

With reference to FIGS. 3A and 3B, recess 6 is constructed having spirally configured driver engageable surfaces that mate with the corresponding mating surfaces of driver bit 3 (FIGS. 5-6). As discussed below, the spirally configured driver engageable surfaces, and the corresponding mating surface, may be referred to herein as wings of a fastener, or lobes and/or projections or a driver bit. However, for purposes of this discloser wings, lobes, and/or projections will be used interchangeably for discussing common features of both the recess and the driver.

A cross section of the recess is provided in FIGS. 3A and 3B. The driver engageable surfaces define a plurality of wings 7. Similarly to prior art spirally configured fasteners, the overall shapes and number of wings may be varied from the example illustrated. For example, the shape may include 2, 3, 4, 5, 6, or more wings. Each of the wings within a single recess have a substantially similar shape including an installation surface 8, an outer transition surface 11, and a removal surface 9 that together define the respective wings 7. An inner transition surface 10 extends between the installation and removal surfaces of adjacent wings as shown in FIG. 3B.

The overall shape of the recess 6 and driver bit 3 is similar, except the bit 3 is smaller to provide a clearance between driver and fastener to promote engagement and removal of the driver bit 3 from the recess 6. In addition, the driver bit installation and removal walls are slightly different from the corresponding recess walls so rotation of the bit will provide a full face to face engagement on both the removal and installation wall. As indicated above, the driver/fastener interface surfaces are configured in the general shape of a segment of a spiral on both of the installation and removal surfaces.

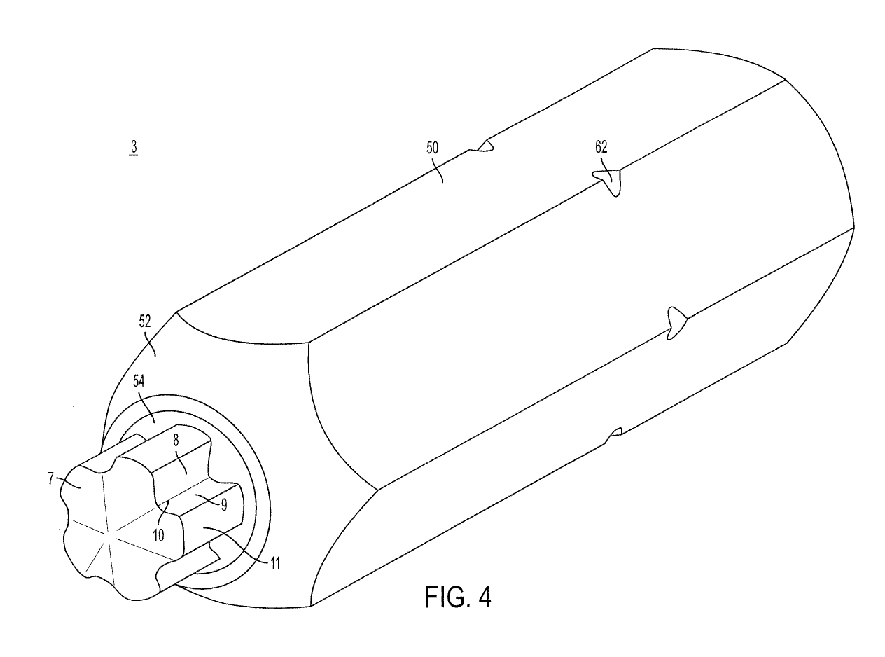

FIGS. 4-5 show various views of an example driver bit 3 including mating surfaces for engagement with the driver engageable surface of the fastener recess. Example bit 3 includes a shaft 50, which may include a portion 52 that is chamfered toward the mating surface. The chamfer angle β of the portion 52 may be any angle. In one example the chamfer angle of the portion 52 is about 60 degrees with respect to an axis perpendicular to the longitudinal axis of the bit 3 (or about 30 degrees with respect to the longitudinal axis of the bit 3). The portion 52 may be chamfered to a minimum diameter of (FIG. 5D).

The driver may include a countersink region 54 between the shaft 50 and the mating surfaces corresponding to the countersink of the recess. The countersink region 54, in one example may be chamfered at an angles (FIG. 5D). In one example, s is less than the chamfer angle α of the recess countersink. Or, in one example, about 80 degrees. In one example, the maximum diameter of the countersink region 54 is øE. In one example embodiment, the countersink region 54 transitions into the mating surfaces 56 through a curve having radius R1.

The mating surfaces 56 of the driver extend a length H from the shaft 50. In one example, the bit 3 includes a bit point 58 extending beyond the mating surfaces 56 from the shaft 50. The bit point 58, in one example, is chamfered at an angle δ (FIG. 5D) with respect to an axis perpendicular to the longitudinal access of bit 3. In one example, δ is between about 16 degrees and about 17 degrees, inclusive. In one example the mating surfaces 56 transitions into the bit point 58 through a curve having radius R2.

The bit 3 may include notches 62 in the bit 50 for use with a quick release bit holder (not shown). The notches may have any shape or location in accordance with an appropriate quick release holder. In one example, the notches 62 have an angle γ and are positioned a length 64 from a back end of the shaft 50. In one example γ is about 90 degrees with a curve radius of about 0.010 inches and length 64 is about 5/16 of an inch with a notch angle offset of about 30 degrees.

The engagement surfaces of the pin 2 shank tip 24 have been shown to be recessed to receive the shown mating male configured driver. However, it is equally possible to provide the engagement surfaces as external surfaces of shank tip 24 for engagement with a female configured driver, as shown in FIGS. 13 a and b of the '358 patent incorporated herein by reference.

The details of the shapes of the driver bit and recess shape are shown in FIGS. 6A and 6B. For simplicity, only a cross sectional view of a driver bit will be described, it being understood that the recess is similarly shaped, albeit with slightly different dimensions, as discussed previously. Further, a recess would appear as a reverse image of the driver bit shape depending on the view direction, as shown for example in FIGS. 3A and 3B.

FIGS. 6A and 6B illustrate a cross section of an example six winged bit 3 with a cross section of two prior art spiral drivers 70 and 72 in phantom. It is observed that the cross sectional shape of bit 3 is constructed with an increased core 12 diameter øB over the core 12′, 12″ diameters of the prior art spiral driver 70 (øB′) and 72 (øB″). The overall diameter øA remains unchanged between the compared drivers, thereby requiring a shortening of the height h of each wing 7 in order to accommodate the enlarged core diameter øB. This results in a reduced surface area for the driving surfaces as well as an increase in the corresponding recess volume with an anticipated deficit to performance and/or fastener strength. In certain example having the recess in the shaft tip, this also results in an increase in core diameter with respect to the thread diameter (both major and minor thread diameter). The cross section of wing 7 is further modified by moving the installation 8 and removal 9 surfaces outward in a parallel manner to form a truncated wing shape with a blunt outer transition surface 11. The blunt outer transition surface 11 is constructed to conform to a segment of a circle, concentric with the core 12, having a diameter øA larger than the core diameter øB. The installation and removal surfaces 8 and 9 are constructed to intersect the core diameter in an inner transitional surface 10 between adjacent wings, for example, wings 7a and 7f with inner transitional surface 10 d. The transitional surface 10 has a concave form that conforms to the core diameter. The transition from the inner transition surface 10 to the installation surface may conform to a curve having radius C (FIG. 5C) and the transition from the installation surface 9 and the outer transition surface may conform to a curve having a radius D (FIG. 5C).

As shown in FIG. 6B, an enlarged section of FIG. 6A, a cross section of a 6-winged bit 3 has wings or projections 7. The wings 7 are defined respectively by installation drive surfaces 8, outer transition surfaces 11, and removal drive surfaces 9. Adjacent wings intersect the core circumference 12 in inner transitions surfaces 10. For comparison, the prior art drivers 70, 72 are shown in phantom having wings extending outward from cores with a diameters (øB′ and øB″) and defined by installation drive surfaces 46′, 46″ and removal drive surfaces 48′, 48″ (FIG. 6A).

Instead of a deficit in performance, these changes have resulted in an increase in corresponding driver strength and a significant rise in seating torque capability for spiral drive fastener systems without detrimental impact to the pin 2. This is particular advantageous to pin configurations in which the recess 6 is within the shank tip 24 of a threaded shank 5, where an increased recess size should result in a decreased wall strength between the outer transition surfaces of the wings and the minor diameter of the threads. The reduction in drive surface area is offset by the improved distribution characteristics from the drive surfaces to the core.

Tables 1 and 2 show example dimensions in inches (unless otherwise marked) for non-limiting example configurations of a five winged recess (table 1) and corresponding five lobed/projection driver (table 2). Also shown are minimum torsional moments applied for successful tests of example pins and driver bits. The indicated dimensions and corresponding strengths, represented in the chart of table 1, are indicative of the significant advantage provided by the fastener system of this application.

TABLE 1
(inches)

| DRIVE | Thread | Thread | Thread | | | | P | T | øY |
|---|---|---|---|---|---|---|---|---|---|
| SIZE | Size | Major ø | Minor ø | øA | øB | øC | (max) | (min) | (max) |
| MTS-IN-2 | .1640-32 | 0.1640 | 0.1268 | 0.0940 | 0.0726 | 0.0709 | 0.1181 | 0.0685 | 0.1189 |
| MTS-IN-2 | .1900-32 | 0.1900 | 0.1528 | 0.0940 | 0.0726 | 0.0709 | 0.1181 | 0.0685 | 0.1189 |
| MTS-IN-3 | .2160-28 | 0.2160 | 0.1734 | 0.1118 | 0.0864 | 0.0827 | 0.1378 | 0.0776 | 0.1421 |
| MTS-IN-4 | .2500-28 | 0.2500 | 0.2074 | 0.1361 | 0.1052 | 0.1024 | 0.1677 | 0.0945 | 0.1732 |
| | | | | | | | | Torsional | |
| | | | | | | | | moment | |
| | | | | | | | øB/ | applied for | |
| | | | | | | | Thread | successful | |
| | DRIVE | øY | | | | | Major | test (min) | |
| | SIZE | (min) | w | h | h/w | øB/øA | ø | IN-LBS | N-M |
| | MTS-IN-2 | 0.1039 | 0.03450 | 0.01069 | 0.30983 | 0.77261 | 0.4429 | 27 | 3 |
| | MTS-IN-2 | 0.1039 | 0.03400 | 0.01069 | 0.31438 | 0.77261 | 0.3823 | 34 | 3.8 |
| | MTS-IN-3 | 0.1220 | 0.04100 | 0.01270 | 0.30968 | 0.77289 | 0.4001 | 44 | 5 |
| | MTS-IN-4 | 0.1531 | 0.05000 | 0.01545 | 0.30906 | 0.77292 | 0.4208 | 71 | 8 |

TABLE 2
(inches)

| DRIVE | | | C | D | | F | | R1 | R1 | R2 | | | | |
|---|---|---|---|---|---|---|---|---|---|---|---|---|---|---|
| SIZE | øA | øB | (rad) | (rad) | øE | (Min) | H | (min) | (max) | (max) | w | h | h/w | øB/øA |
| MTS-IN-2 | 0.0900 | 0.0692 | 0.0031 | 0.0034 | 0.100 | 0.125 | 0.070 | 0.007 | 0.010 | 0.003 | 0.0321 | 0.0104 | 0.3240 | 0.7689 |
| MTS-IN-3 | 0.1078 | 0.0829 | 0.0037 | 0.0041 | 0.120 | 0.130 | 0.084 | 0.007 | 0.010 | 0.004 | 0.0384 | 0.01245 | 0.3242 | 0.7690 |
| MTS-IN-4 | 0.1313 | 0.1010 | 0.0045 | 0.0050 | 0.146 | 0.180 | 0.102 | 0.007 | 0.010 | 0.004 | 0.0468 | 0.01515 | 0.3237 | 0.7692 |

The increased strength of the system and the increased seating torque, may be attributed to the recess and driver being constructed with a core diameter that is increased over the prior art spiral fastener system. It would have been logical to try to maintain the area of the drive surfaces by constructing the transition surface as a convex continuation of the installation and removal surfaces 7 and 8. Instead according to subject matter of this application, the drive surfaces 8 and 9 are constructed to intersect the core diameter in a transitional surface 10 between the wings 7 that has a concave form conforming to the core diameter. This adds to core strength, but further truncates the wing cross section and reduces drive surface area. In addition, by truncating the outer tip of the wing cross section and moving the drive surfaces outward in parallel with the prior art configuration, the wing may be enlarged and formed with a blunt tip, the strength of the system maybe further increased. It is observed that the center of mass of the wing will also be moved outward, thereby effecting an improved load distribution.

This is accompanied by a shortening of the radial extension of the wing of both recess and driver cross sections beyond the core diameter. The wing cross section of the driver/recess is further modified by moving the installation and removal surfaces in a parallel manner to form a truncated wing shape with a blunt tip. The blunt tip is constructed to conform to a circle, concentric with the core, with a diameter larger than the core diameter.

In one example, to accomplish this, the cross section of the wing portion of the recess 6 (and therefore also the wing portion of the bit 3) is truncated both outward from the core circumference 12 and inward from the outer transition surface 11. In this manner, the wings 7 are constructed so that the ratio of core diameter øB to the wing outer transition surface to the diameter øA, in one example, is greater than 0.70 and the transition surface 10 between the wings 7 is a concave segment of the core circumference. In another example, the ratio of core diameter øB to the wing outer transition surface to the diameter øA is greater than 0.77. An in yet another example, the ratio of core diameter øB to the wing outer transition surface to the diameter øA is between about 0.77 and about 0.78.

In addition, the width w of the wings 7 (recess), or corresponding projections of the bit, is enlarged while maintaining the profile of the drive surfaces to be consistent with the prior fastener system. The ratio h/w of the height h of the wing cross section to its width w is constructed to be approximately equal to or less than 0.4 in one example. In another example, equal to or less than about 0.35. And in other examples equal to or less than about 0.32 or between about 0.30 and 0.32 (inclusive). In comparison, the prior art faster systems ratio of øB/øA may be calculated to be approximately 0.46 and 0.66, respectively and the ratio of prior art fastener systems (h/w) may be calculated to be approximately 0.9 and 0.5.

In certain described examples, the ratio of the core diameter øB to the corresponding major thread diameter may be calculated to be greater than or equal to about 0.3. In another example, the ratio of the core diameter øB to the corresponding major thread diameter may be calculated to be greater than or equal to about 0.35. In another example, the ratio of the core diameter øB to the corresponding major thread diameter may be calculated to be between (and including) about 0.3 and about 0.45. Or in other examples, between (and including) about 0.38 and about 0.50

These modified dimensions have proven to provide a significant advantageous improvement in bit strength.

Although the subject matter of this application is discussed with reference to a fastener system having spirally configured drive surfaces, it is believed that the construction and method is equally applicable to other cruciform style fastener systems, in particular, a hexalobular style fastener system as described in U.S. Pat. No. 6,017,177 and ISO 10664, titled “Hexalobular internal driving feature for bolts and screws” and available at iso.org.

In this manner a new and unique fastener system is presented that provides an improvement in strength characteristics with respect to the driver without a deficit to the overall performance of the fastener system.

It should be understood that the above description is only illustrative of the invention. Various alternatives and modifications can be devised by those skilled in the art without departing from the invention. Accordingly, the present invention is intended to embrace all such alternatives, modifications and variances which fall with the scope of the appended claims.

What is claimed as new and desired to be protected by Letters Patent of the United States is:

1. A fastener system, comprising:
a fastener having a head, a shank, and a recess, wherein the recess comprises driver engageable surfaces that define a plurality of wings radially extending from a central core; and
a driver having an end constructed with mating surfaces for engagement with the driver engageable surfaces of the fastener recess, wherein the mating surfaces define a plurality of projections radially extending from a central core matching the wings;
wherein each of said wings of the recess comprise a cross sectional shape comprising an installation surface, an outer transition surface, and a removal surface that define the wing, and wherein each of the wings are connected by an inner transition surface extending between the installation and removal surfaces of adjacent wings;
wherein the cross sectional shape comprises a wing having a width and a height and the ratio of the wing height to the wing width is approximately equal to or less than 0.4; and
wherein the driver engageable surfaces of the recess are constructed to receive the mating surfaces of the driver.

2. The fastener system of claim 1, wherein the recess central core has a first radius and the outer transition surface has a second radius and wherein the ratio of the first radius to the second radius is greater than 0.70.

3. The fastener system of claim 1, wherein the recess central core has a first radius and the outer transition surface has a second radius and wherein the ratio of the first radius to the second radius is greater than 0.77.

4. The fastener system of claim 1, wherein the recess central core has a first radius and the outer transition surface has a second radius and wherein the ratio of the first radius to the second radius is within the range of about 0.77 to about 0.78.

5. The fastener system of claim 1, wherein the driver engageable surfaces are constructed in the shape of a spiral segment and said mating surfaces have a matching shape.

6. The fastener system of claim 1, wherein the wings are arranged in an pentalobular configuration.

7. The fastener system of claim 1, wherein the multiple wings consist of five wings.

8. The fastener system of claim 1, wherein the shank is a threaded shank having a shank tip on an opposite end of the fastener from the head, and the recess is recessed in the shank tip.

9. The fastener system of claim 8, wherein the mating surfaces are external surfaces on a driver end.

10. The fastener system of claim 1, wherein the driver engageable surfaces are external surfaces of the shank tip and wherein the mating surfaces are recessed in a driver end.

11. The fastener system of claim 1, wherein the inner transition surface conforms to a circumference of the central core.

12. The fastener system of claim 8, wherein the threaded shank comprises external threads having a major diameter at a thread crest and a minor diameter at a thread root, the fastener has a central core diameter at the inner transition surface, and the ratio of the central core diameter to the major diameter is greater than about 0.3.

13. The fastener system of claim 12, wherein the ratio of the central core diameter to the major diameter is between about 0.3 to about 0.45.

14. The fastener system of claim 12, wherein the ratio of the central core diameter to the major diameter is greater than about 0.38 and less than about 0.50.

15. The fastener system of claim 8, wherein the threaded shank has a threaded portion and an unthreaded portion, the unthreaded portion being between the threaded portion and the head.

16. The fastener system of claim 8, wherein the driver engageable surfaces are countersunk from the shank tip in a longitudinal direction toward the head.

17. The fastener system of claim 16, wherein the countersink is chamfered from a first diameter to a second diameter, the first diameter being larger than the second diameter and the first diameter being closer to the shank tip than the second diameter.

18. The fastener system of claim 17, wherein the chamfer has a chamfer angle of about 100 degrees.

19. The fastener system of claim 1, wherein the driver end is chamfered to a point, the chamfer having an angle of between about 16 degrees and about 17 degrees.

20. The fastener system of claim 1, wherein the driver comprises a shaft.

21. The fastener system of claim 20, wherein the driver shaft is chamfered toward the mating surfaces at an angle of about 30 degrees with respect to a longitudinal axis of the driver.

22. The fastener system of claim 20, wherein the driver further comprises a countersink region corresponding to the countersink of the recess, wherein the driver countersink is chamfered at an angle less than the chamfer angle of the recess countersink.

23. The fastener system of claim 22, wherein the chamfer angle of the driver countersink is about 80 degrees and a chamfer angle of the recess countersink is about 100 degrees.

24. The fastener system of claim 20, wherein the shaft comprises at least one notch.

25. The fastener system of claim 8, wherein, the driver comprises a shaft, the driver engageable surfaces extend a length from the shank tip, and the mating surfaces of the driver extend a length from the shaft, wherein the length from the shank tip is greater than the length from the shaft.

26. A fastener, comprising:
a head, a shank, and a recess, wherein the recess comprises driver engageable surfaces that define a plurality of wings radially extending from a central core; and
wherein each of said wings of the recess comprise a cross sectional shape comprising an installation surface, an outer transition surface, and a removal surface that define the wing, and wherein each of the wings are connected by an inner transition surface extending between the installation and removal surfaces of adjacent wings;
wherein at least one of the installation and removal surfaces being configured to define a segment of a spiral; and
wherein the driver engageable surfaces of the recess are constructed to receive mating surfaces of the driver;
wherein the shank has a shank tip on an opposite end of the fastener from the head, and the recess is recessed in the shank tip.

27. The fastener of claim 26, wherein the cross sectional shape comprises a wing having a width and a height and the ratio of the wing height to the wing width is approximately equal to or less than 0.4; and

28. The fastener of claim 26, wherein the recess central core has a first radius and the outer transition surface has a second radius and wherein the ratio of the first radius to the second radius is greater than 0.70.

29. The fastener of claim 26, wherein the recess central core has a first radius and the outer transition surface has a second radius and wherein the ratio of the first radius to the second radius is greater than 0.70.

30. The fastener of claim 26, wherein the recess central core has a first radius and the outer transition surface has a second radius and wherein the ratio of the first radius to the second radius is greater than 0.77.

31. The fastener of claim 26, wherein the recess central core has a first radius and the outer transition surface has a second radius and wherein the ratio of the first radius to the second radius is within the range of about 0.77 to about 0.78.

32. The fastener of claim 26, wherein the wings are arranged in a pentalobular configuration.

33. The fastener of claim 26, wherein the multiple wings consist of five wings.

34. The fastener of claim 26, wherein the driver engageable surfaces are external surfaces of the shank tip and wherein the mating surfaces are recessed in a driver end.

35. The fastener of claim 26, wherein the inner transition surface conforms to a circumference of the central core.

36. The fastener of claim 26, wherein the threaded shank comprises external threads having a major diameter at a thread crest and a minor diameter at a thread root, the fastener has a central core diameter at the inner transition surface, and the ratio of the central core diameter to the major diameter is greater than about 0.3.

37. The fastener of claim 36, wherein the ratio of the central core diameter to the major diameter is between about 0.3 to about 0.45.

38. The fastener of claim 36, wherein the ratio of the central core diameter to the major diameter is greater than about 0.38 and less than about 0.50.

39. The fastener of claim 26, wherein the threaded shank has a threaded portion and an unthreaded portion, the unthreaded portion being between the threaded portion and the head.

40. The fastener of claim 26, wherein the driver engageable surfaces are countersunk from the shank tip in a longitudinal direction toward the head.

41. The fastener of claim 40, wherein the countersink is chamfered from a first diameter to a second diameter, the first diameter being larger than the second diameter and the first diameter being closer to the shank tip than the second diameter.

42. The fastener of claim 41, wherein the chamfer has a chamfer angle of about 100 degrees.

43. A method of manufacturing a fastener having a head, a shank, and a shank tip on an opposite end of the fastener from the head, the method comprising:
forming a starter hole;
forming driver engageable surfaces that define a plurality of wings radially extending from a central core, wherein each of said wings of the recess comprise a cross sectional shape comprising an installation surface, an outer transition surface, and a removal surface that define the wing, and wherein each of the wings are connected by an inner transition surface extending between the installation and removal surfaces of adjacent wings; and,
wherein at least one of the installation and removal surfaces is formed to define a segment of a spiral.

44. The method of claim 43, wherein the forming driver engageable surfaces comprises broaching.

45. The method of claim 43, wherein the forming driver engageable surfaces comprises punching.
